(19) United States
(12) Patent Application Publication
(10) Pub. No.: US 2009/0236198 A1
(43) Pub. Date: Sep. 24, 2009

(54) Game machine rewarded with tokens or tickets

(76) Inventor: Yi-Chiang Yang, Changhwa (TW)

Correspondence Address: CHARLES E. BAXLEY, ESQUIRE, 90 JOHN STREET, SUITE 309, NEW YORK, NY, 10038, US

(21) Appl. No.: 12/077,998

(22) Filed: Mar. 24, 2008

(51) Int. Cl. G07F 7/00

(52) U.S. Cl. 194/205

(57) ABSTRACT

A game machine includes a push device including a horizontal board and a push member which is movable on a top surface of the horizontal board. The tokens that are pushed to drop from the edge of the horizontal board are selectively guided to either the token collection box or the pick-up box by switching the switch gate. If the player chooses to get tokens as reward, the tokens are guided to the pick-up box. If the player chooses to get tickets as reward, the tokens are guided to the token collection box and the ticket unit is activated to dispense tickets.

### FIELD OF THE INVENTION

The present invention relates to a game machine and more particularly, to a token pushing machine which provides tokens or tickets to the players.

### BACKGROUND OF THE INVENTION

A conventional token pushing game machine generally includes a frame with a pushing device located therein and a pick-up box is located beneath the pushing device. The pushing device includes a horizontal board and a pushing member is movable on the board. Players insert tokens from the insertion unit and the tokens drop on the board and pile up, the pushing member move to push the tokens and some tokens drop from the edge of the board. The tokens drop from the board and are collected in the pick-up box from which the players may pick the tokens as the reward.

The players can redeem the tokens to get treats or the players insert the tokens into the game machine again to play the token pushing game. If the player wants to redeem the token, he or she has to leave the game machine and redeem the tokens at an exchange office, once the player leaves the game machine, other players may take that spot and play the machine. Some arcades allow the players to redeem their tokens with tickets which are then collected to a certain number to redeem the treats. Nevertheless, none of the game machines provide tokens and tickets in one machine so that the players can only get tokens or tickets from one machine.

The present invention intends to provide a game machine which provides tokens or tickets as rewards and the players can choose either token or tickets as rewards.

### SUMMARY OF THE INVENTION

The present invention relates to a game machine that comprises a main frame having a push device and an insertion unit is connected to the push device. The push device includes a horizontal board and a push member is movable on a top surface of the horizontal board. A counting device is located corresponding to the push device. The counting device includes a counting unit, a split unit, a pick-up box, a token collection box and a ticket unit. The counting unit of the counting device is located corresponding to an outlet of the horizontal board and an outlet of the counting unit is located to the split unit. The split unit includes a guide box which has an outlet and a switch gate is pivotably located to the outlet of the guide box. A driving member is located at a top of the guide box and drives the switch gate via a belt connected therebetween. The token collection box includes a first passage which is located corresponding to the outlet of the split unit and the pick-up box includes a second passage which is located corresponding to the outlet of the split unit. Tokens are selectively guided to either the token collection box or the pick-up box by switching the switch gate, the ticket unit dispenses tickets when tokens are send into the token collection box.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the game machine of the present invention;

FIG. 2 is a perspective view to show the game machine with the push device removed;

FIG. 3 is a perspective view to show the game machine with the push device and main frame removed;

FIG. 4 is a perspective view to show the counting device of the game machine of the present invention;

FIG. 5 is a perspective view to show the split unit of the game machine of the present invention;

FIG. 6 shows that the tokens are collected to the token collection box from the split unit of the game machine of the present invention, and

FIG. 7 shows that the tokens are available in the pick-up box from the split unit of the game machine of the present invention.

### DETAILED DESCRIPTION OF THE PREFERRED EMBODIMENT

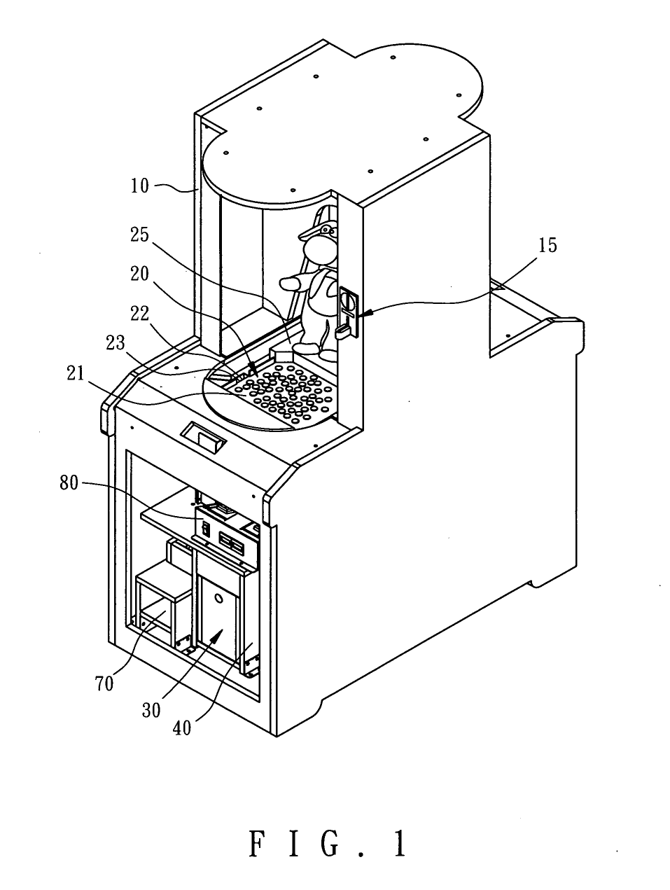

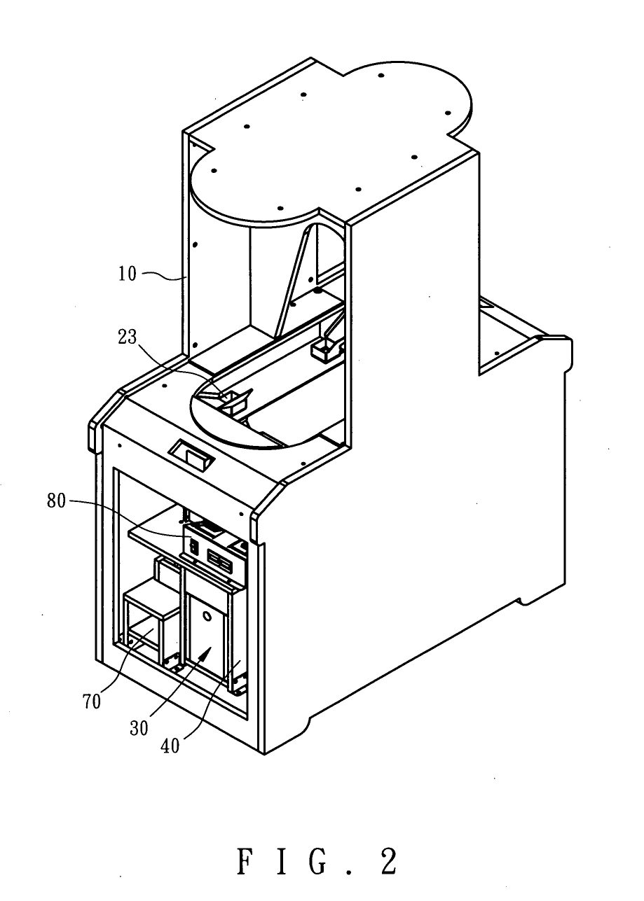

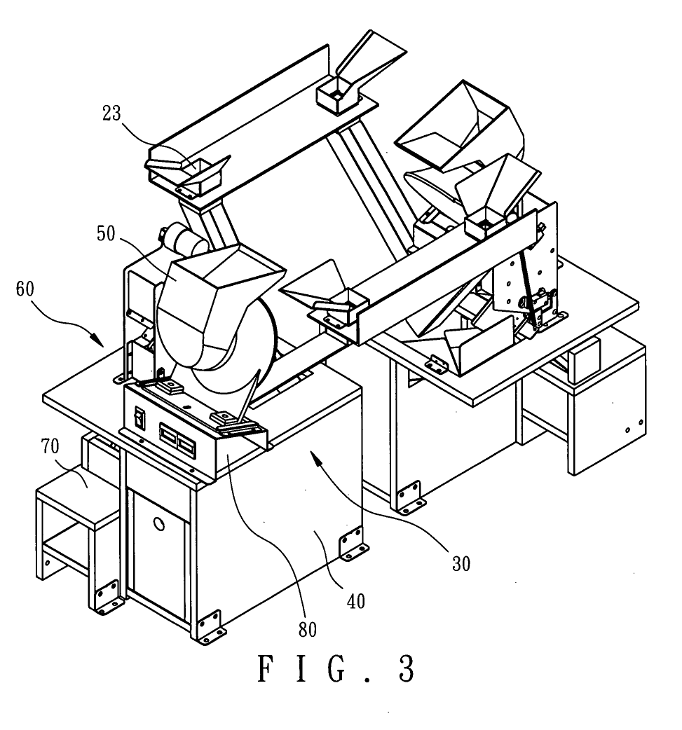

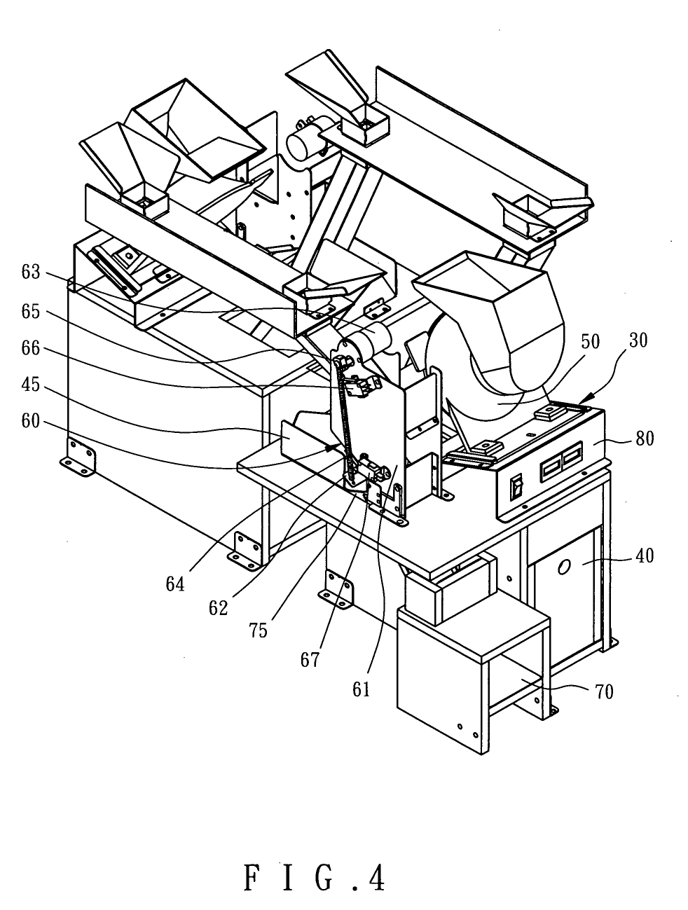

Referring to FIGS. 1 to 7, the game machine of the present invention comprises a main frame 10 having a push device 20 received therein and an insertion unit 15 is connected to the push device 20 so that tokens are inserted into the insertion unit 15 and drop on the push device 20. The push device 20 includes a horizontal board 21 and a push member 25 which is movable on a top surface of the horizontal board 21. Two side outlets 22 are defined in two sides of the horizontal board 21 and a return passage 23 communicates with the two side outlets 22. The tokens are piled on the horizontal board 21 and pushed by the push member 25, some of the tokens drop from the edge of the horizontal board 21 and enter the side outlets 22.

A counting device 30 is located corresponding to the push device 20 and includes a counting unit 50, a split unit 60, a pick-up box 70, a token collection box 40 and a ticket unit 80. The counting unit 50 of the counting device 30 is located corresponding an outlet of the horizontal board 21 of the push device 20. An outlet of the counting unit 50 is located to the split unit 60. The split unit 60 includes a guide box 61 which has an outlet and a switch gate 62 is pivotably located to the outlet of the guide box 61. A driving member 63 is located at a top of the guide box 61 and a belt 64 is connected between the driving member 63 and the switch gate 62 which is driven by the driving member 63 via the belt 64.

The token collection box 40 includes a first passage 45 which is located corresponding to the outlet of the split unit 60 and the pick-up box 70 includes a second passage 75 which is located corresponding to the outlet of the split unit 60. The return passage 23 communicates with the token collection box 40 of the counting device 30.

A touch plate 65 is located at an output shaft of the driving member 63. A first detection member 66 and a second detection member 67 are located corresponding to the touch plate 65 and the switch gate 62. The first detection member 66 selectively cuts off the driving member 63 and the second detection member 67 detects that the switch gate 62 returns to its initial position.

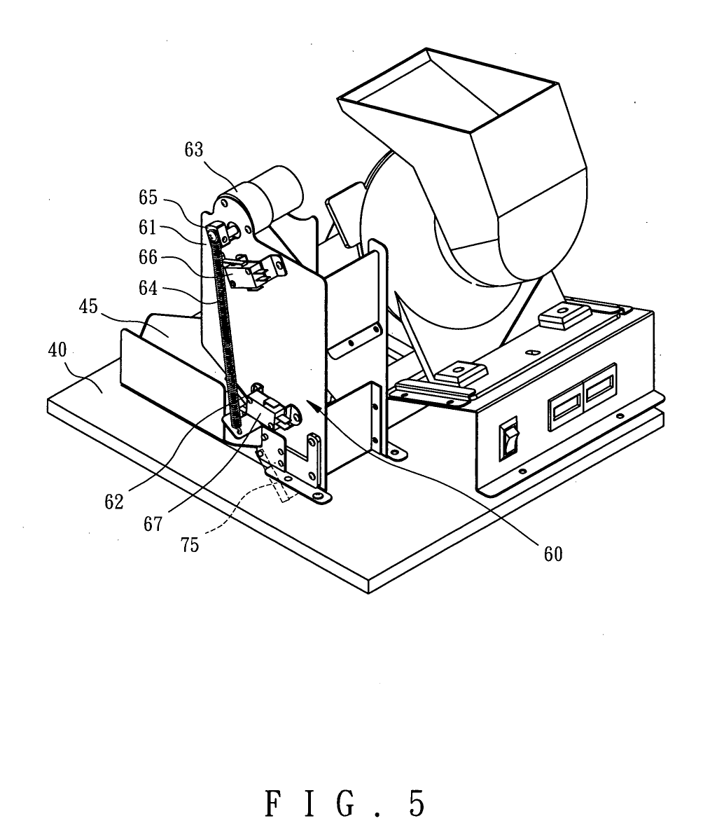

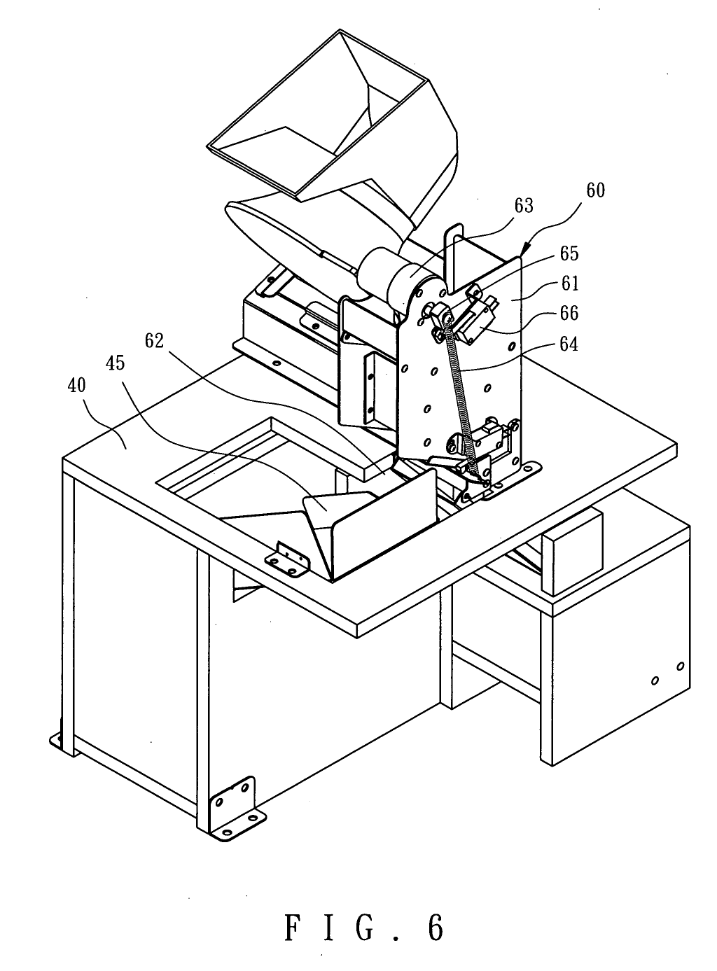

The tokens that is pushed to drop and enter into counting unit 50 of the counting device 30, the counting unit 50 counts the number of the tokens which enters the guide box 61 of the split unit 60. The player chooses one of the options to allow the tokens to set the switch gate 62 via the driving member 63 and the belt 64. If the switch gate 62 is set to be at upper position, the tokens drop into the pick-up box 70 via the second passage 75 as shown in FIGS. 5 and 6, so that the player can pick up the tokens.

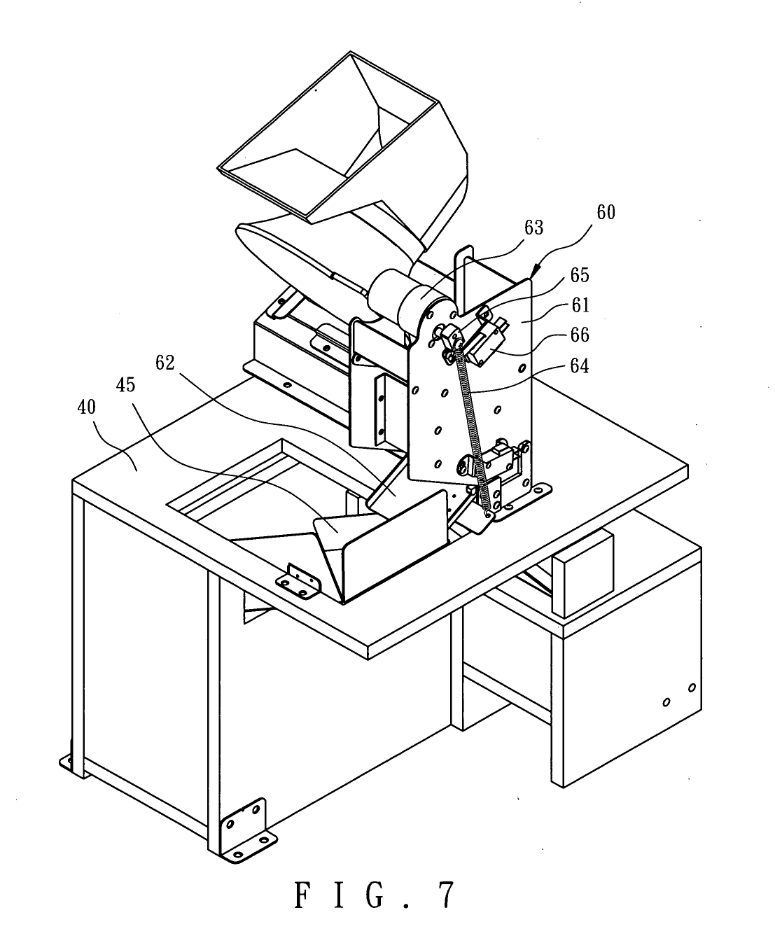

If the switch gate 62 is set to a lower position, the tokens enter the token collection box 40 via the first passage 45 as shown in FIG. 7. The ticket unit 80 is then activated to dispense tickets.

The game machine of the present invention allows the players to set tokens or tickets as their reward without leaving the game machine.

While we have shown and described the embodiment in accordance with the present invention, it should be clear to those skilled in the art that further embodiments may be made without departing from the scope of the present invention.

What is claimed is:

1. A game machine comprising:
a main frame having a push device and an insertion unit connected to the push device, the push device including a horizontal board and a push member which is movable on a top surface of the horizontal board, a counting device located corresponding to the push device;
the counting device including a counting unit, a split unit, a pick-up box, a token collection box and a ticket unit, the counting unit of the counting device located corresponding to an outlet of the horizontal board of the push device, an outlet of the counting unit located to the split unit, the split unit including a guide box which has an outlet and a switch gate pivotably located to the outlet of the guide box, a driving member located at a top of the guide box and a belt connected between the driving member and the switch gate which is driven by the driving member via the belt, and
the token collection box including a first passage which is located corresponding to the outlet of the split unit, the pick-up box including a second passage which is located corresponding to the outlet of the split unit, tokens selectively guided to either the token collection box or the pick-up box by switching the switch gate, the ticket unit dispensing tickets when tokens are send into the token collection box.

2. The game machine as claimed in claim 1, wherein two side outlets are defined in two sides of the horizontal board and a return passage communicates with the two side outlets, the return passage communicates with the token collection box of the counting device.

3. The game machine as claimed in claim 1, wherein a touch plate is located at an output shaft of the driving member, a first detection member and a second detection member are located corresponding to the touch plate and the switch gate, the first detection member selectively cuts off the driving member and the second detection member detects that the switch gate returns to its initial position.
